(19) United States
(12) Patent Application Publication
(10) Pub. No.: US 2010/0209742 A1
(43) Pub. Date: Aug. 19, 2010

(54) METHOD OF MANUFACTURING A GLASS SUBSTRATE FOR A MAGNETIC RECORDING MEDIUM, A GLASS SUBSTRATE FOR A MAGNETIC RECORDING MEDIUM MANUFACTURED BY THE METHOD, AND A PERPENDICULAR MAGNETIC RECORDING MEDIUM

(75) Inventor: Hiroshi MINAZAWA, Minami-Alps City (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO. LTD., Tokyo (JP)

(21) Appl. No.: 12/708,002

(22) Filed: Feb. 18, 2010

(30) Foreign Application Priority Data
Feb. 18, 2009 (JP) 2009-035639

(51) Int. Cl. G11B 5/667; G11B 5/73; C03C 19/00

(52) U.S. Cl. 428/846.9; 428/141; 65/61

(57) ABSTRACT

The present invention provides a method of manufacturing a glass substrate for a magnetic recording medium, the method allowing the surface roughness of the glass substrate being controlled easily and precisely in a stable state. The method comprises a step of finish polishing of polishing a surface of the glass substrate with a slurry containing two types of colloidal silica particles having different diameters and mixed in a predetermined ratio.

### BACKGROUND OF THE INVENTION

A. Field of the Invention

The present invention relates to a method of manufacturing a glass substrate for a magnetic recording medium, the surface roughness of which can be adjusted, a glass substrate for a magnetic recording medium manufactured by the method, and a perpendicular magnetic recording medium.

B. Description of the Related Art

Hard disk drives using a magnetic recording medium are installed in external memories of computers and digital home appliances, for example, mobile information devices such as mobile music reproduction devices as well as in other devices. The recording system of those magnetic recording media practically used today are a longitudinal recording system in which the axis of easy magnetization of a magnetic recording layer is oriented in a direction parallel to the substrate surface and a perpendicular magnetic recording system in which the axis of easy magnetization is oriented in a direction perpendicular to the substrate surface.

The perpendicular magnetic recording system exhibits stable magnetization in a magnetization inversion region and enhanced thermal fluctuation characteristics and noise performances, even in magnetic recording media with high recording density. Quality of reproduced signals in magnetic recording media in the perpendicular recording system depends on perpendicular alignment property of the axis of easy magnetization of a magnetic recording layer. If the perpendicular alignment property of the axis of easy magnetization is inadequate, a leakage flux of the magnetic recording layer tilts from the substrate surface. As a result, the media noise increases and the S/N performance degrades. For this reason, a substrate for use in magnetic recording media needs to have an extremely smooth surface configuration in order to achieve high recording density.

It is also important for achieving high recording density in a magnetic recording medium that a flying height of a magnetic head is made low from the surface of the magnetic recording medium. Hard disk drives using a magnetic recording medium installed in, for example, a car navigation system, which is a vehicle-mounted device, need to assure stable gliding performance of a magnetic head even in an environment of low atmospheric pressure experienced at a place of high elevation in a course of traveling of the car and an environment of externally subjected vibration. A condition needs to be established for the magnetic head to float stably even in a low atmospheric pressure.

Glass substrates, which exhibit high intensity and high anti-shock performance, are occasionally used for substrates for magnetic recording media to meet this requirement. A glass substrate can easily obtain a smooth surface as compared with an aluminum substrate.

For the purpose of achieving a small flying height of a magnetic head, Japanese Unexamined Patent Application Publication No. 2000-200414 discloses a method of manufacturing a magnetic recording medium including a process of machining on a glass substrate, the process comprising successively conducted steps of rough grinding, mirror grinding on the end surface, lapping, first polishing with a hard polisher, second polishing with a soft polisher, third polishing with a ultra-soft polisher, and chemical strengthening. The steps are conducted so as to set the surface roughness (Rmax and Ra) of the glass substrate and the ratio of the values of surface roughness (Rmax/Ra) within predetermined ranges.

Japanese Unexamined Patent Application Publication No. 2003-036528 discloses a method of manufacturing a magnetic recording medium with the objective of ensuring stable gliding of a magnetic head and reduce the flying height by equalizing the height of projections of fine irregularities on the glass substrate. The method comprises, after a chemical strengthening step on the glass substrate, a step of precision polishing treatment to attain abrasion quantity in the thickness direction of the glass substrate in a predetermined range.

Japanese Unexamined Patent Application Publication No. 2003-036522 discloses a method of manufacturing a magnetic recording medium that is used in recording and reproduction in CSS (contact start and stop) scheme and intended to obtain high electromagnetic conversion characteristics and high CSS endurance. The method comprises sequentially conducted steps of rough grinding, mirror machining on the end surface, lapping, first polishing with a hard polisher, second polishing with a soft polisher, and surface treatment, to control the surface roughness of the glass substrate surface. The step of surface treatment includes sequential processes of immersing the polished glass substrate in two different types of hydrosilicofluoric acid with different concentrations.

Japanese Unexamined Patent Application Publication No. 2005-317181 discloses a glass substrate for a magnetic disk exhibiting a stable flying performance manufactured by a process including a texturing step on the glass substrate. The texture consisting of texture elements having circumferential component and crossing each other so that the angle of crossing is increased from the outer peripheral side to the inner peripheral side on the whole principal surface of the glass substrate. This means can give magnetic anisotropy property to the magnetic layer formed on the substrate surface, stabilizing the flying performance of the magnetic head especially in the inner circumferential region.

It is a hard procedure in controlling the surface roughness of a glass substrate to precisely adjust the surface roughness of a glass substrate within a predetermined range by changing the condition of each polishing step as disclosed in Japanese Unexamined Patent Application Publication Nos. 2000-200414 and 2003-036528. The procedure disclosed in Japanese Unexamined Patent Application Publication No. 2003-036522 for controlling the surface roughness of a glass substrate within a predetermined range by the surface treatment step of sequentially immersing the substrate in two different types of hydroxisilicofluoric acid with different concentration, involves a problem of stability in controlling the surface roughness in the mass production stage of glass substrates because the surface roughness is extremely sensitive to the concentration, temperature, and immersion time of the hydroxisilicofluoric acid.

The glass substrate disclosed in Japanese Unexamined Patent Application Publication No. 2005-317181 is not suited for a perpendicular magnetic recording medium because in the glass substrate with the anisotropic texture, the soft magnetic layer is greatly affected by the magnetic shape anisotropy and the axis of easy magnetization orients in the substrate plane.

The present invention is directed to overcoming or at least reducing the effects of one or more of the problems set forth above.

### SUMMARY OF THE INVENTION

The present invention provides a method of manufacturing a glass substrate for a magnetic recording medium, the method allowing the surface roughness of the glass substrate being controlled easily and precisely in a stable state. The invention also provides a glass substrate for a magnetic recording medium manufactured by such a method. The invention also provides a perpendicular magnetic recording medium including such a glass substrate.

The method of manufacturing a glass substrate for a magnetic recording medium according to the invention comprises a step of finish polishing of polishing a surface of the glass substrate with a slurry containing two types of abrasion particles, wherein the surface of the glass substrate polished in the step of finish polishing has an arithmetic mean roughness Ra controlled within 1.0 nm and with a precision in the range of ±0.05 nm.

A glass substrate for a magnetic recording medium of the invention is manufactured by the method of manufacturing a glass substrate for a magnetic recording medium as stated above.

A magnetic recording medium of the invention comprises: the glass substrate for a magnetic recording medium according to the invention as stated above; and at least a soft-magnetic layer, an orientation control layer, and a perpendicular recording layer sequentially laminated on a surface of the glass substrate for a magnetic recording medium.

The method of the invention comprises a step of finish polishing to polish the surface of the glass substrate with a slurry containing two types of abrasion particles, and the surface of the glass substrate polished in the finish polishing step has an arithmetic mean roughness Ra controlled within 1.0 nm and with a precision in the range of ±0.05 nm. Therefore, the surface roughness of the glass substrate is controlled easily and precisely in a stable state as described in the following.

### BRIEF DESCRIPTION OF THE DRAWINGS

The foregoing advantages and features of the invention will become apparent upon reference to the following detailed description and the accompanying drawings, of which:

FIG. 1 shows variation of the surface roughness of a glass substrate corresponding to weight ratio of mixing two types of abrasion particles in a slurry used in an example of the manufacturing method of a glass substrate for a magnetic recording medium according to the invention;

FIG. 2 shows variation of the surface roughness of a glass substrate corresponding to salt concentration in a slurry used in another example of the manufacturing method of a glass substrate for a magnetic recording medium according to the invention;

FIG. 3 shows variation of the surface roughness of a glass substrate corresponding to hydrogen ion concentration exponent (pH) in a slurry used in still another example of the manufacturing method of a glass substrate for a magnetic recording medium according to the invention;

FIG. 4 is a partially enlarged sectional view of an example of a perpendicular magnetic recording medium according to the invention;

FIG. 5 shows a series of steps of manufacturing a perpendicular magnetic recording medium, to which an example of the method of manufacturing a glass substrate for a magnetic recording medium according to the invention is applied;

FIG. 6 shows a schematic construction of a double-sided polishing machine used in an example of the method of manufacturing a glass substrate for a magnetic recording medium according to the invention;

FIG. 7 shows variation of the surface roughness of a glass substrate corresponding to a diameter of the second type of abrasion particles contained in the slurry used in an example of the manufacturing method of a glass substrate for a magnetic recording medium according to the invention;

FIG. 8 shows variation of the surface roughness of a glass substrate corresponding to the number of continuous machining at three target values of surface roughness in an example of the manufacturing method of a glass substrate for a magnetic recording medium according to the invention;

FIG. 9 illustrates interaction energy acting between surfaces of two substances;

FIG. 10 shows a zeta potential as a function of the hydrogen ion concentration exponent pH for silica;

FIG. 11 is a table showing set values of the weight ratio of mixing two types of abrasion particles in the slurry used in examples of the manufacturing method of glass substrate for a magnetic recording medium according to the invention;

FIG. 12 is a table showing set values of the weight ratio of mixing two types of abrasion particles in the slurry used in examples of the manufacturing method of glass substrate for a magnetic recording medium according to the invention;

FIG. 13 is a table showing set values of the salt concentration in the slurry used in other examples of the manufacturing method of glass substrate for a magnetic recording medium according to the invention; and

FIG. 14 is a table showing set values of the hydrogen ion concentration exponent pH in the slurry used in still other examples of the manufacturing method of glass substrate for a magnetic recording medium according to the invention.

### DETAILED DESCRIPTION OF SPECIFIC EMBODIMENTS

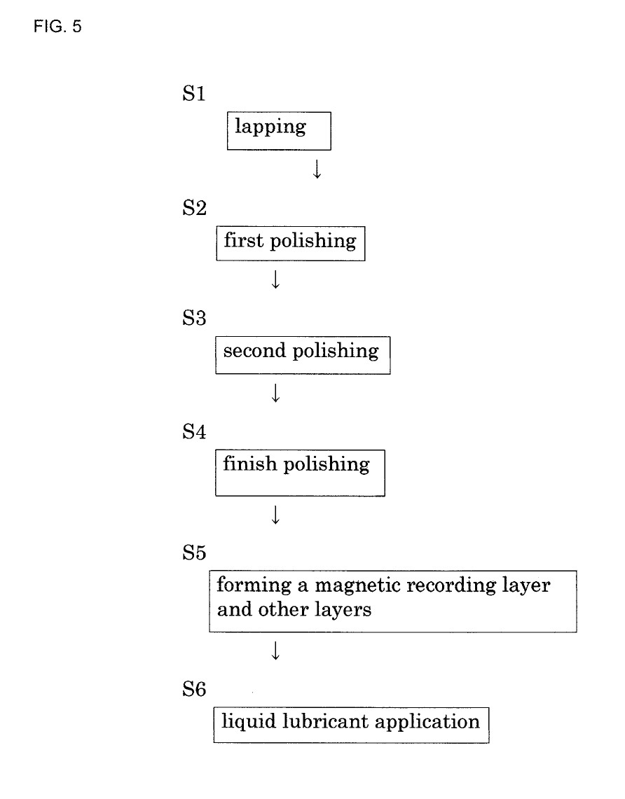

FIG. 5 shows a series of steps of manufacturing a disk shaped magnetic recording medium, to which an example of the method of manufacturing a glass substrate for a magnetic recording medium according to the invention is applied.

Disk shaped magnetic recording medium 10 is obtained through the series of steps shown in FIG. 5. It is a perpendicular magnetic recording medium designed to have an outer diameter, an inner diameter, and a thickness of, for example, about 48 mm, about 15 mm, and about 0.5 mm, respectively. Disk shaped magnetic recording medium 10 comprises, as shown in the partially enlarged view of FIG. 4, soft magnetic layer 14, orientation control layer 16, perpendicular recording layer 18, protective layer 20, and liquid lubricant layer 22 successively laminated on a surface of non-magnetic substrate 12. FIG. 4 is a schematic sectional view of disk shaped magnetic recording medium 10 cut along the radial direction.

Soft magnetic layer 14, orientation control layer 16, perpendicular recording layer 18, and protective layer 20 are successively formed by a thin film formation method selected from a sputtering method, a CVD method, a vacuum evaporation method, and a plating method, for example.

Substrate 12 is made of amorphous glass, crystallized glass, quartz glass, or silicon, for example. The material for substrate 12 is not limited to these examples, but can be a substance exhibiting a polishing property similar to glass.

Soft magnetic layer 14 can be formed of an amorphous soft magnetic material of CoZrNb or a soft magnetic material of FeTaC.

Orientation control layer 16 can be formed of a CoCr alloy, titanium, titanium-based alloy, or ruthenium when the magnetic recording layer (perpendicular recording layer 18) is a perpendicular magnetization film of a CoCr alloy. When the magnetic recording layer is a so-called laminated perpendicular magnetization film, which is a lamination of a cobalt-based alloy and platinum or a cobalt-based alloy and palladium, the orientation control layer 16 can be formed of platinum or palladium.

A material for the orientation control layer 16 is not limited to these materials, but can be any material that can favorably control crystal orientation and crystal grain size of the magnetic recording layer.

Perpendicular recording layer 18, a magnetic recording layer, is formed of a so-called perpendicular magnetization film that can be composed of the CoCr alloy, or a lamination of the cobalt-based alloy and platinum or a lamination of the cobalt-based alloy and palladium. A material for perpendicular recording layer 18 is not limited to these examples, but can be formed of any material that can perform recording and reproduction function in a perpendicular magnetic recording medium.

Protective layer 20 is formed of a thin film of mainly carbon, for example.

After forming protective layer 20, liquid lubricant layer 22 can be provided applying a liquid lubricant of perfluoropolyether by a dip coating method, for example.

In the process for manufacturing disk shaped magnetic recording medium 10, lapping step 51 is first conducted as shown in FIG. 5. After cleaning the surface of a disk shaped raw material for a substrate having a thickness of about 1 mm, for example, by alkali cleaning, lapping step 51 polishes it by lapping until the thickness decreases to about 0.53 mm. The lapping work is carried out using a lapping machine (not shown in the figures) with a cast iron table. The working liquid contains 10 wt % of #1500 silicon carbide (SiC), for example, and the working pressure is set at 100 gf/cm², for example. After the lapping step, the polished substrate is washed and dried.

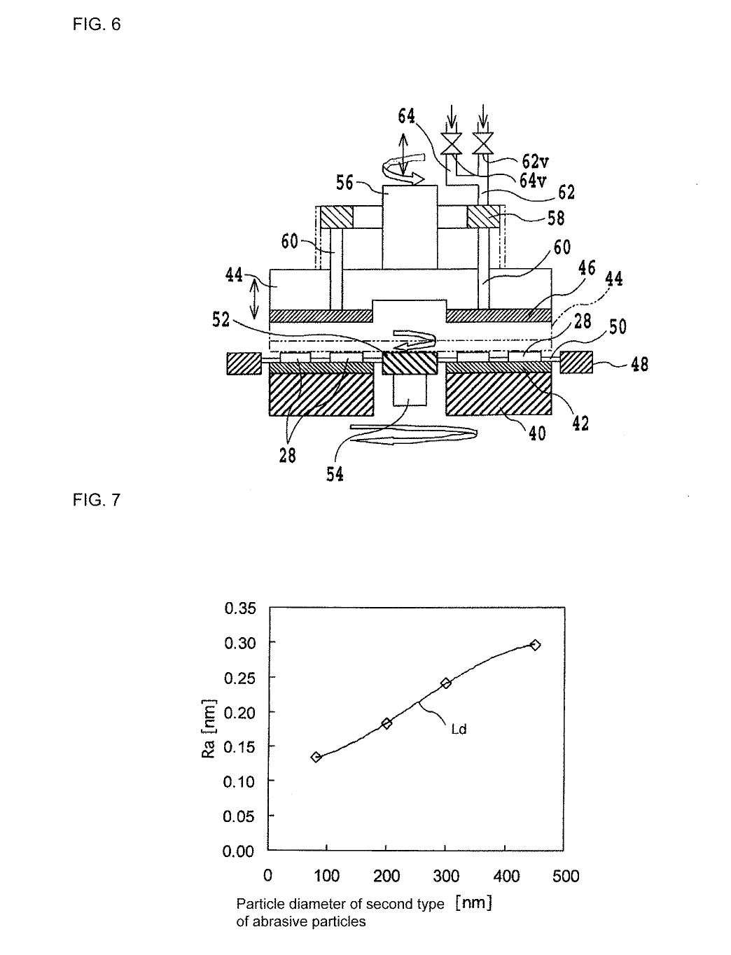

Next in first polishing step S2, the substrate treated in the preceding step is polished by a double-sided polishing machine as shown in FIG. 6 until the thickness decreases to about 0.502 mm.

The double-sided polishing machine is composed of main components of: lower surface plate 40 having ring shaped sheet 42 of abrasive cloth on one surface thereof and rotatably supported, upper surface plate 44 opposing lower surface plate 40 and disposed rotatably and allowed to approach to or leave from lower surface plate 40, drive shaft 54 disposed in a central opening of lower surface plate 40 and having sun gear 52 that transmits a driving force to annular gear 48 through a row of planetary gears (not shown in the figure) supported by carrier 50, annular gear 48 surrounding the outer periphery of lower surface plate 40 and connected to lower surface plate 40 to transmit a driving force from the row of planetary gears to lower surface plate 40, a vertically driving mechanism (not shown in the figure) for raising or lowering upper surface plate 44 to leaving from or approaching to lower surface plate 40, and a drive motor for rotating lower surface plate 40 and upper surface plate 44.

Upper surface plate 44 has a hollow disk shaped sheet of abrasive cloth 46, which is a polishing pad of urethane foam, on the surface opposing abrasive cloth 42. An end of drive shaft 56 is connected to the central part of upper surface plate 44 at a common center line with drive shaft 54. To the other end of drive shaft 56, an output part of the drive motor and the vertically driving mechanism are connected. When the drive motor is operated in this construction, drive shaft 56 with upper surface plate 44 is rotated in the direction of the arrow in FIG. 6 and pushed towards lower surface plate 40 by the vertically driving mechanism at a predetermined pressure.

A rotating speed of drive shaft 56 with upper surface plate 44 is controlled according to a predetermined characteristic curve that is represented on a plane with an ordinate of the rotating speed of drive shaft 56 and an abscissa of polishing time.

Abrasive liquid storage member 58 having a toroidal shape is placed around drive shaft 56. Abrasive liquid storage member 58 supplies pure water and slurry, which will be described later, through feed lines 60 to the place between abrasive cloth 42 and abrasive cloth 46. Abrasive liquid storage member 58 is connected to upper surface plate 44 with a support member (not shown in the figure). Abrasive liquid storage member 58 has a toroidal groove (not shown in the figure) therein for storing the water and slurry to feed. Ends of the plurality of feed lines 60 are connected to the groove. Feed lines 60 are positioned along the circumferential direction of abrasive liquid storage member 58 with a distance of predetermined angle. The other end of each feed line 60 opens to the place between upper surface plate 44 and lower surface plate 40 through upper surface plate 44 and abrasive cloth 46.

Right above the groove of abrasive liquid storage member 58, an end of supply line 62 for supplying pure water is disposed with a predetermined distance from the groove. The other end of feed line 62 is connected to a pure water tank (not shown in the figure) for storing pure water. Feed line 62 is provided with control valve 62V for controlling the quantity of pure water supply.

An end of feed line 64 for supplying slurry to feed line 62 is connected to feed line 62 at a position in the upstream side away from abrasive liquid storage member 58. The other end of feed line 64 is connected to a slurry tank (not shown in the figure) for storing slurry. Feed line 64 is provided with control valve 64V for controlling the quantity of slurry supply.

Consequently, slurry or pure water is supplied through feed line 62. When drive shaft 56 is rotated, the slurry or pure water is supplied through the groove in rotating abrasive liquid storage member 58 and feed lines 60 to the place between abrasive cloth 42 and abrasive cloth 46.

Carrier 50 works as a substrate-holding member and has a plurality of holes for holding substrates 28 to be polished. Each of the holes has a diameter larger than the diameter of the substrate by a predetermined dimension. Substrate 28 disposed in each hole is rotatable on the axis thereof.

When the drive motor connected to drive shaft 54 is operated, lower surface plate 40 rotates in the direction of the arrow in FIG. 6, that is, a direction reversed to the rotation direction of upper surface plate 44. A rotational speed of lower surface plate 40 is also controlled according to the characteristic curve described previously.

When drive shafts 54 and 56 are rotated, the sliding surface of substrates 28 held on carrier 50 is subjected to relative motion to abrasive cloth 42 and lower surface plate 40 that are rotated with annular gear 48, and abrasive cloth 46, and is polished with the supplied slurry. Since the quantity of polish per unit time is proportional to the predetermined pressure between upper surface plate 44 and lower surface plate 40 and the rotational speed, the required polishing quantity can be controlled by setting a polishing time at a predetermined value.

In an example of a method of manufacturing a magnetic recording medium using the double-sided polishing machine, first polishing step S2 is conducted with a slurry of 10 wt % ceria having a particle diameter of 1.5 μm and a working pressure of 100 gf/cm².

The surface of substrates 28 are polished in the state of control valve 64V opened and control valve 62V closed to supply the slurry to the substrates. After the predetermined time has passed after the start of polish, control valve 64V is closed and control valve 62V is opened, to wash substrates 28 readily removing the slurry on substrates 28 with the pure water.

Subsequently in second polishing step S3 shown in FIG. 5, the substrate polished in first polishing step S2 is further polished using the double-sided polishing machine. This step is conducted in the conditions with a slurry of 10 wt % colloidal silica with a particle diameter of 80 nm and a working pressure of 100 gf/cm². Substrates 28 are polished in step S3 to a thickness of about 0.500 mm using the double-sided polishing machine.

The double-sided polishing machine is operated in this step in the same manner as in first polishing step S2. The polished substrates are then washed and dried.

Subsequently in finish polishing step S4 shown in FIG. 5, the substrates polished in second polishing step S3 are further subjected to a finish polishing in finish polishing step S4 shown in FIG. 5 using the double-sided polishing machine shown in FIG. 6. A working pressure in this step is set at 100 gf/cm².

In an example of the method according to the invention of manufacturing a glass substrate for a magnetic recording medium, a slurry used in the finish polishing step is prepared by mixing two types of colloidal silica with different particle diameters (a first type of abrasive particles and a second type of abrasive particles, which will be described afterwards) with a predetermined ratio and adjusting a final weight concentration of the total colloidal silica to be 10 wt % using pure water. The colloidal silica slurry used in this example is a alkaline slurry manufactured by Nissan Chemical Industry, Ltd. The measured values of hydrogen ion concentration exponent (pH) of the slurry after adjusting to the concentration for use in actual polishing operation are all 9.5.

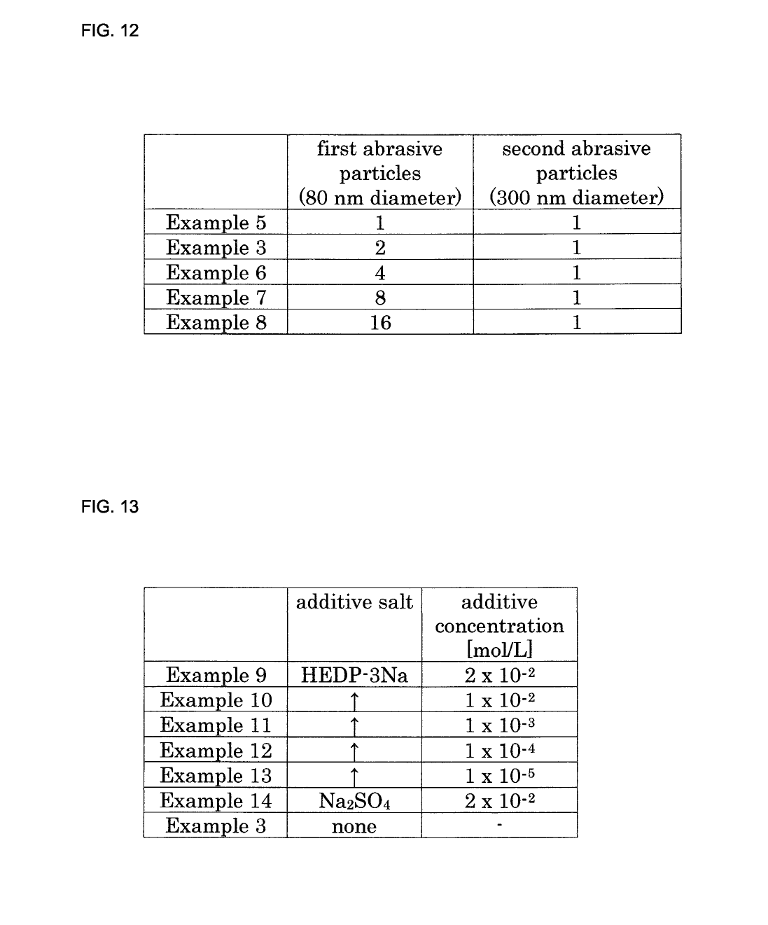

A mixing ratio is selected from weight concentration ratios of colloidal silica as shown in the tables of FIG. 11 and FIG. 12, for example, corresponding to a desired target value of surface roughness Ra of the substrate. The table of FIG. 11 shows the colloidal silica of the first type of abrasive particles with a particle diameter of 80 nm and the colloidal silica of the second type of abrasive particles with particle diameters of 200 nm, 300 nm, and 450 nm used for the examples. The combinations of colloidal silica of the first type of abrasive particles with a particle diameter of 80 nm and each of the colloidal silica of the second type of abrasive particles with a particle diameter of 200 nm, 300 nm, or 450 nm, and the mixing ratios (Examples 2, 3, and 4) are applied to the target values of the surface roughness Ra of the substrate in the range from 0.30 nm to 0.40 nm.

A slurry for use in the finish polishing step can be a mixture of colloidal silica of a first type of abrasive particles with a particle diameter of 80 nm and colloidal silica of a second type of abrasive particles with a particle diameter of 300 nm mixed in the ratio as shown in FIG. 12 (Examples 5 through 8), which are adjusted to the final weight concentration of total colloidal silica of 10 wt % using pure water. The colloidal silica slurry used in these examples is alkaline slurry manufactured by Nissan Chemical Industry, Ltd. The measured values of hydrogen ion concentration exponent (pH) of the slurry after adjusting to the concentration for use in actual operation are all 9.5.

FIG. 7 shows a characteristic curve Ld of the surface roughness Ra (arithmetic mean roughness) of the substrate resulted by the finish polishing conducted on the substrates using some combinations (Examples) of colloidal silica. The ordinate represents the surface roughness Ra of the substrates and the abscissa represents the particle diameter of the colloidal silica shown in the table of FIG. 11. The surface roughness Ra was measured by an atomic force microscope (AFM) under conditions of 10 μm square and 512×512 pixels.

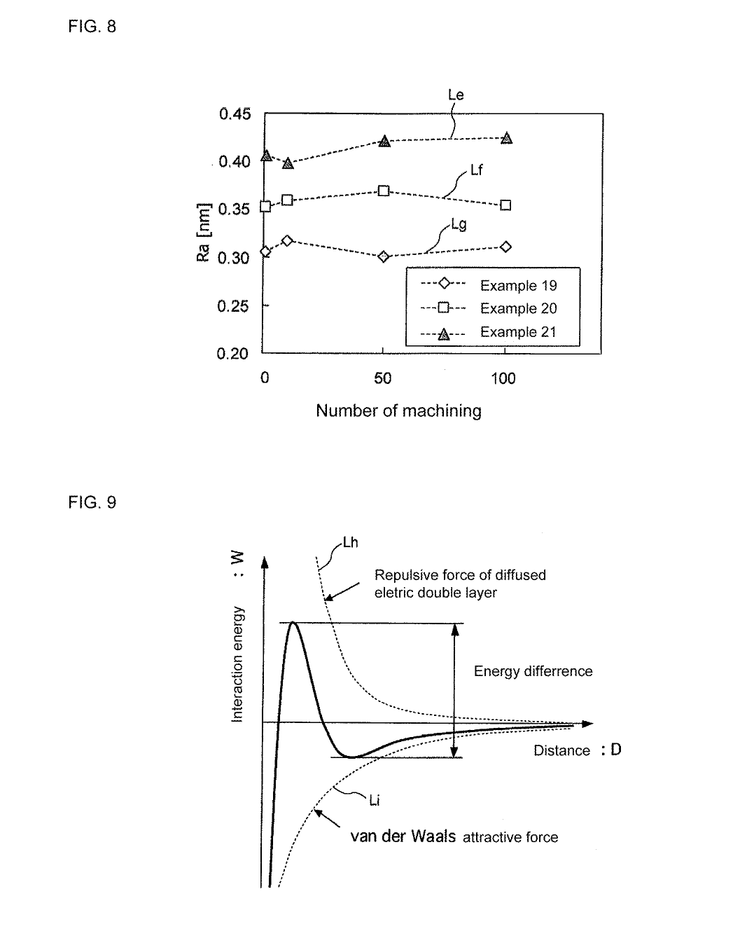

As is clearly shown by the characteristic curve Ld in FIG. 7, a surface roughness corresponding to the particle diameter is obtained by polishing work using a slurry of a mixture of two different types of free abrasive particles having different particle diameters. The precision of the surface roughness is in the range of ±0.05 nm as described afterwards with reference to FIG. 8.

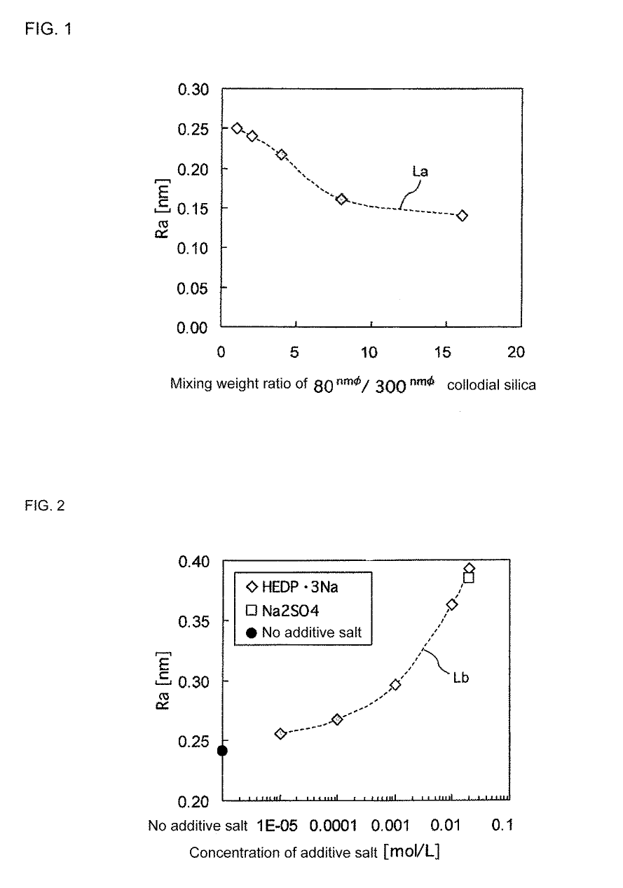

FIG. 1 shows a characteristic curve La of the surface roughness Ra of the substrate resulted by the finish polishing conducted on the substrate using some combinations (Examples) of two types of colloidal silica having a different particle diameter with various mixing weight ratio. The ordinate represents the surface roughness Ra of the substrate and the abscissa represents a mixing weight ratio of the colloidal silica shown in the table of FIG. 12. The surface roughness Ra was measured by an atomic force microscope (AFM) under a condition of 10 μm square and 512×512 pixels.

As is clearly shown by the characteristic curve La in FIG. 1, it has been confirmed by the inventor of the present invention that a predetermined surface roughness is reproduced with high precision by polishing work using a slurry in which the mixing weight ratio of two types of abrasive particles with different particle diameters is adjusted.

As shown in FIG. 1, the surface roughness is large when the mixing ratio of the larger abrasive particles is high, and the limit corresponds to the case of polishing solely using the larger abrasive particles. Thus, the maximum roughness that can be obtained depends on the particle diameter of the larger particles. Likewise, the minimum roughness that can be obtained depends on the particle diameter of the smaller abrasive particles.

It is therefore possible to adjust a surface roughness by mixing two types of abrasive particles with the larger diameter and the smaller diameter and varying the mixing ratio. The range of controllable surface roughness is between the roughness resulting by using a slurry of solely the larger diameter abrasive particles and the roughness resulting by using a slurry of solely the smaller diameter abrasive particles.

In an example of the method according to the invention of manufacturing a glass substrate for a magnetic recording medium, a mixing ratio of two types of abrasive particles with different particle diameters has been noticed by the inventor of the present invention for the following reason.

A surface configuration of a substrate for a perpendicular magnetic recording medium must have an isotropic configuration. To achieve this situation, it is effective to polish the substrate with a slurry containing free abrasive particles using a double-sided polishing machine. One of the factors to control the surface roughness in the polishing process is a size of the free abrasive particles. A larger roughness is generally obtained using free abrasive particles with a larger diameter. The roughness is however virtually fixed by the size of the abrasive particles and hardly adjusted. When two types of abrasive particles, larger diameter abrasive particles and smaller diameter abrasive particles, are mixed and the mixing ratio is appropriately varied, adjustment of the roughness is possible with high stability.

Another factor to control the surface roughness is a scheme to control the contact between the abrasive particle and the glass substrate to be machined. In an actual machining process of the substrate, the substrate is machined with the free abrasive particles in the slurry made in contact with the substrate by the exerted pressure. A degree of the contact of the abrasive particles to the substrate can be adjusted by controlling interaction energy between the abrasive particles and the substrate. Here, machining ability of each abrasive particle is controlled resulting in control of the surface roughness.

In the above-described example of the method according to the invention of manufacturing a glass substrate for a magnetic recording medium, control of surface roughness of the substrate in the finish polishing step is performed relying on solely the mixing ratio in the colloidal silica slurry. However, a slurry for use in the finish polishing step is not limited to that example, but can be the one prepared by, for example, mixing a first type of abrasive particles with a particle diameter of 80 nm and a second type of abrasive particles with a particle diameter of 300 nm in a volume ratio of two to one, and adjusting a final weight concentration of total colloidal silica to be 10 wt % using pure water, and then adding a salt such as shown in the table of FIG. 13 to the slurry in the predetermined concentration.

The slurry used in this example is an alkaline slurry manufactured by Nissan Chemical Industry, Ltd.

The salt is, as shown in FIG. 13, for example, trisodium salt of hydroxyethylidene diphosphonic acid (HEDP-3Na, a salt of an organic acid) or a salt of an inorganic acid of Na₂SO₄. The slurry after the salt is added and adjusted exhibits a hydrogen ion concentration exponent (pH) of 9.5 in each case.

A reason for employing the trisodium salt (HEDP-3Na) is that it exhibits a hydrogen ion concentration exponent (pH) of 9.5 and does not affect the hydrogen ion concentration exponent (pH) of the slurry.

The trisodium salt is prepared by mixing HEDP-2Na and HEDP-4Na in an equal number of moles. The HEDP-2Na and HEDP-4Na used are CHELEST PH-212 and CHELEST PH-214 manufactured by CHELEST Corporation.

A reason for adding the salt to control the surface roughness of the substrate is as follows.

A surface of a particle such as free abrasive particle dispersed in liquid has an electric potential called a surface potential. In a vicinity of the particle surface, a layer called a Stern layer exists in which ions with an opposite sign to the surface potential are fixed. A zeta potential is a potential outside the Stern layer, where an ion cloud (a diffused electric double layer) formed by the zeta potential exists.

Now considering interaction energy between an abrasive particle and a substrate surface, a diffused electric double layer is formed on the surface of each article. The diffused electric double layers superimposes on approaching each other, generating potential energy of electrostatic repulsive (or attractive) force. Meanwhile, every pair of substances commonly undergoes an attractive force of van der Waals force, generating simultaneously a potential energy based on the force.

The sum of the two types of energy is the interaction energy between the abrasive particle and the substrate. This approach is commonly known as DLVO theory. FIG. 9 shows an example of the interaction energy, wherein the ordinate represents the interaction energy W and the abscissa represents the distance D. FIG. 9 shows the curve of the interaction energy obtained from the curve Lh representing the energy based on the diffused electric double layer repulsive force and the curve Li representing the energy based on the van der Waals attractive force.

An event of contact between the abrasive particle and the substrate in an actual machining process means that the distance between the two articles becomes null overcoming the energy difference indicated by the curve depicted in FIG. 9. Since the energy difference directly affects the degree of the contact (ease of the contact) between the abrasive particle and the substrate surface, the surface roughness can be adjusted by adjusting the energy difference. The adjustment of the energy difference can be managed by varying the concentration of an electrolyte in the slurry, for example.

This is because rise of the electrolyte concentration makes the diffused electric double layer thin, reducing the energy difference. As a result, the abrasive particles become in contact with the substrate surface intensely to promote polish machining thereby increasing the surface roughness.

In order to vary the electrolyte concentration in the slurry, the slurry is supplied with an acid, an alkali, or an salt of an acid or an alkali. Since an acid or an alkali changes simultaneously the pH, a salt is preferred. Because the salt is used for the purpose of adjusting the electrolyte concentration in the slurry, any materials can be useful that electrolytically dissociates in the slurry and increases the electrolyte concentration in the slurry regardless of whether it is organic or inorganic material.

Therefore, addition of a salt into the slurry adjusts the electrolyte concentration in the slurry and adjusts the energy difference, thereby adjusting the surface roughness.

FIG. 2 shows the surface roughness of substrates measured by the inventor of the present invention, the substrates being subjected to finish polishing step using the type of slurry adjusted with the salt concentration according to the examples shown in the table of FIG. 13. FIG. 2 shows a characteristic curve Lb indicating change of surface roughness of the substrates, wherein the ordinate represents the surface roughness of the substrate and the abscissa represents the salt concentration. The substrates in these examples are similar to the substrate 28 as described previously. The surface roughness was measured by an AFM (atomic force microscope) under the conditions of 10 μm square and 512×512 pixels.

As is clearly shown by the characteristic curve Lb in FIG. 2, it has been confirmed that the surface roughness increases with increase of the concentration of the added trisodium salt (HEDP-3Na). Since the range of variation of the surface roughness is from 0.25 nm to 0.45 nm, which is around a size of an atom, control of the surface roughness with high precision has also been demonstrated. In the cases of other mixing weight ratios, the surface roughness of the substrate increases with increase in the concentration of the added salt as well. Addition of a salt other than the trisodium salt, namely, Na₂SO₄ likewise resulted in increase of the surface roughness.

Thus, it has been demonstrated that the surface roughness can be controlled with high precision by adding a salt to the slurry and adjusting the concentration thereof to use in polishing process. From the fact that the similar effect has been obtained with a salt of an inorganic acid of Na₂SO₄ as well as with a salt of an organic acid of HEDP-3Na, it has been shown that any electrolyte component is useful to obtain the effect regardless of the type of the added salt.

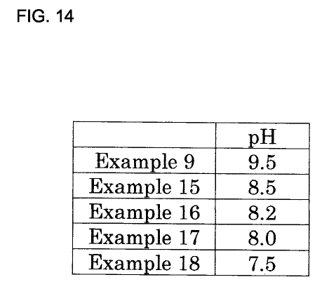

In the examples of the method of manufacturing a glass substrate for a magnetic recording medium according to the invention, the slurry for use in the finish polishing step is prepared by mixing a first type of abrasive particles with a particle diameter of 80 nm in a volume proportion of 2 and a second type of abrasive particles with a particle diameter of 300 nm in a volume proportion of 1 and adjusting to a final weight concentration of total colloidal silica of 10 wt % using pure water, and then a salt is added to the slurry in a predetermined additive concentration as shown in the table of FIG. 13. The slurry is not limited to those examples, but the hydroxyethylidene diphosphonic acid (HEDP) can be further added to adjust a hydrogen ion concentration exponent (pH) of the slurry in the range of 7.5 to 8.5 as shown in the table of FIG. 14.

In these examples, a reason for adjusting the hydrogen ion concentration exponent (pH) in order to control the surface roughness of the substrate is described in the following.

As described previously, since the energy difference directly affects the degree of contact (ease of contact) between the abrasive particle and the substrate surface, the adjustment of the energy difference has the effect to adjust the surface roughness. The adjustment of the energy difference can be also carried out by adjusting the hydrogen ion concentration exponent (pH) of the slurry.

This is because variation of the zeta potential, a surface potential, which varies corresponding to the hydrogen ion concentration exponent (pH), brings about variation of the energy difference. A large absolute value of the zeta potential results in a large energy difference.

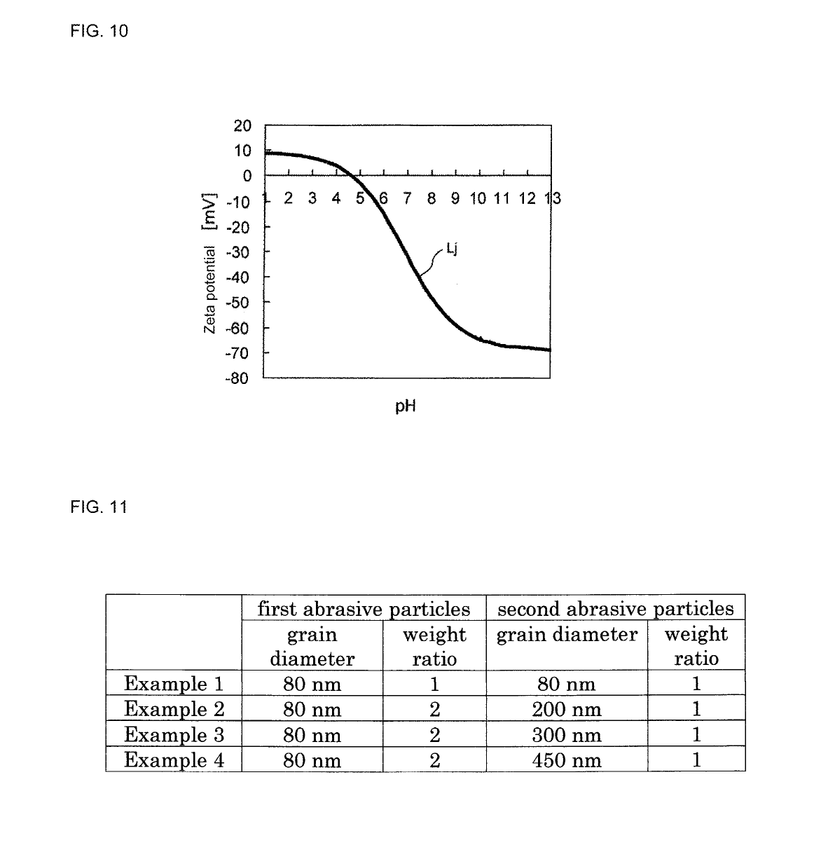

FIG. 10 illustrates a characteristic curve Lj showing the zeta potential of ordinary silica, wherein the ordinate represents the zeta potential and the abscissa represents the hydrogen ion concentration exponent (pH). As is clearly shown in FIG. 10, the zeta potential varies with variation of the hydrogen ion concentration exponent (pH). Thus, adjustment of the hydrogen ion concentration exponent (pH) adjusts the energy difference, thereby adjusting the surface roughness of the substrate. In order to adjust the hydrogen ion concentration exponent (pH) of the slurry, an acid or an alkali is added to the slurry. Since the acid and alkali are used for the purpose of adjusting the hydrogen ion concentration exponent (pH), any substance can be used that gives a target value of the hydrogen ion concentration exponent (pH) regardless of organic materials or inorganic materials.

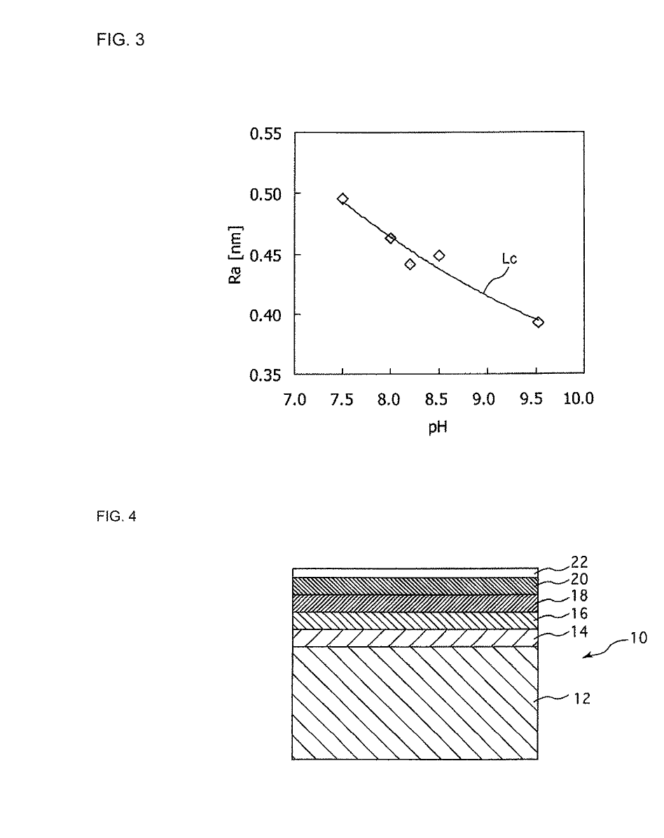

FIG. 3 shows the surface roughness, measured by the inventor of the present invention, of the substrates subjected to the finish polishing step using the types of slurry, the hydrogen ion concentration exponent (pH) of which is adjusted according to the Examples indicated in the table of FIG. 14.

FIG. 3 illustrates the characteristic curve Lc showing variation of the surface roughness of the substrates corresponding to variation of hydrogen ion concentration exponent (pH), wherein the ordinate represents the surface roughness of the substrates and the abscissa represents the hydrogen ion concentration exponent (pH). The substrate in these examples are similar to substrate 28 previously described. The surface roughness was measured by an AFM (atomic force microscope) under the conditions of 10 μm square and 512×512 pixels.

As is clear from the characteristic curve Lc in FIG. 3, the surface roughness of the substrate varies corresponding to the hydrogen ion concentration exponent (pH). Since the surface roughness of the substrate varies in the range of the atomic size level, high precision control of the surface roughness has been demonstrated.

The inventor of the present invention has further made experimentations independently varying the factors (parameters) for controlling the surface roughness including the mixing weight ratio, the salt concentration, and the hydrogen ion concentration exponent (pH) to control the surface roughness, and has studies on stability in continuous operation.

In this study, the substrates undergone the first polishing step and the second polishing step are then treated by the finish polishing, which is described in detail in the following, and the surface roughness of the substrates was measured.

FIG. 8 shows the characteristic curves Lg, Lf, and Le indicating variation of surface roughness of the substrate measured corresponding to the number of machining, wherein the ordinate represents surface roughness Ra and the abscissa represents the number of machining (batch number of machining).

The characteristic curve Lg indicates the surface roughness Ra of the substrates which were subjected to continuous machining (polishing) and sampled at the number of machining of 1, 10, 50, and 100. The continuous machining was conducted for a target surface roughness of Ra=0.30 nm using a slurry with the following parameters: a mixing weight ratio of 80 nm/300 nm diameter colloidal silica=8, a weight concentration of total colloidal silica=10 wt %, a concentration of the trisodium salt of hydroxyethylidene diphosphonic acid (HEDP-3Na)=2×10⁻² [mol/L], and pH=8.3.

The characteristic curve Lf indicates the surface roughness Ra of the substrates which were subjected to continuous machining (polishing) and sampled at the number of machining of 1, 10, 50, and 100. The continuous machining was conducted for a target surface roughness of Ra=0.35 nm using a slurry with the following parameters: a mixing weight ratio of 80 nm/300 nm diameter colloidal silica=4, a weight concentration of total colloidal silica=10 wt %, a concentration of the HEDP-3Na=2×10⁻² [mol/L], and pH=9.7.

The characteristic curve Le indicates the surface roughness Ra of the substrates which were subjected to continuous machining (polishing) and sampled at the number of machining of 1, 10, 50, and 100. The continuous machining was conducted for a target surface roughness of Ra=0.40 nm using a slurry with the following parameters: a mixing weight ratio of 80 nm/300 nm diameter colloidal silica=4, a weight concentration of total colloidal silica=10 wt %, a concentration of the HEDP-3Na=2×10⁻² [mol/L], and pH=8.4.

The values of the control factors for the surface roughness described above were determined using a mixing weight ratio lower than the one to give the target surface roughness and intending to raise the surface roughness by the concentration of salt and to finely adjust by the hydrogen ion concentration exponent (pH).

As is clearly shown by the characteristic curves Le, Lf, and Lg in FIG. 8, the surface roughness is adjusted in a precision within ±0.05 nm for all the target surface roughness Ra and remains stable with increase in the number of machining. Therefore, the surface roughness is controlled with high precision even in a mass production stage.

Even if the surface roughness deviates from the intended value in mass production, the slurry does not need to be prepared anew and can be readily adjusted by adding a salt or adjusting pH. Therefore, the method of the invention is well suited to mass production.

The largest surface roughness Ra depends on the particle diameter of the abrasive particles used. However, even in the case using silica with a particle size of 450 nm in Example 4 in the table of FIG. 11, it is possible to obtain a surface roughness Ra of 1 nm by setting the hydrogen ion concentration exponent (pH) at 5.5, in which the colloidal silica does not aggregate, and a concentration of the salt (HEDP-3Na) at 0.1 [mol/L]. Consequently, it is possible to obtain a largest surface roughness of at least 1.0 nm. Therefore, it can be sufficiently stated that high precision control is possible when the surface roughness Ra is not greater than 1.0 nm.

The above-described control factors (parameters) for surface roughness including the mixing weight ratio, the salt concentration, and the hydrogen ion concentration exponent (pH) can be separately applied according to the object. For example, an initial slurry is prepared based on the mixing weight ratio and the salt concentration, and then, subsequent fine adjustment is conducted based on the hydrogen ion concentration exponent (pH).

After the finish polishing process described so far, in step S5 of forming a magnetic recording layer and other layers in FIG. 5, soft magnetic layer 14, orientation control layer 16, perpendicular recording layer 18, and protective layer 20 are successively formed on the surface of finish polished substrate 28 by the thin film forming method described earlier. Then in step S6 of liquid lubricant application, a liquid lubricant is applied by a dip coating method. Thus, a disk shaped magnetic recording medium is obtained.

After that, the resulting magnetic recording medium 10 is measured for TOP (take off pressure) to evaluate floating characteristic of a magnetic head. The TOP is an indicator of ease of floating of a magnetic head. A magnetic disk drive is placed in a pressure controllable environment and the pressure is gradually increased. The TOP is a pressure at which the magnetic head takes off. A low TOP value means that a magnetic head is readily floats. The inventor's study has shown that the TOP tends to decrease with increase in the surface roughness of the substrate.

Thus, a method of manufacturing a glass substrate for a magnetic recording medium, a glass substrate for a magnetic recording medium manufactured by the method, and a perpendicular magnetic recording medium have been described according to the present invention. Many modifications and variations may be made to the techniques and structures described and illustrated herein without departing from the spirit and scope of the invention. Accordingly, it should be understood that the methods and devices described herein are illustrative only and are not limiting upon the scope of the invention.

This application is based on, and claims priority to, Japanese Patent Application No. 2009-035639, filed on Feb. 18, 2009. The disclosure of the priority application in its entirety, including the drawings, claims, and the specification thereof, is incorporated herein by reference.

What is claimed is:

1. A method of manufacturing a glass substrate for a magnetic recording medium comprising finish polishing a surface of the glass substrate with a slurry containing two types of abrasion particles, wherein the surface of the glass substrate polished with the finish polishing has an arithmetic mean roughness Ra controlled within 1.0 nm and with a precision in the range of ±0.05 nm.

2. The method of manufacturing a glass substrate for a magnetic recording medium according to claim 1, wherein the slurry contains a first type of abrasion particles and a second type of abrasion particles having a diameter different from that of the first type of abrasion particles, in a predetermined mixing ratio.

3. The method of manufacturing a glass substrate for a magnetic recording medium according to claim 2, wherein the slurry further contains an additive of salt in a predetermined concentration.

4. The method of manufacturing a glass substrate for a magnetic recording medium according to claim 3, wherein the slurry further contains an additive of acid or alkali in an amount so as to exhibit a predetermined hydrogen ion concentration exponent (pH).

5. A glass substrate for a magnetic recording medium that is manufactured by finish polishing a surface of the glass substrate with a slurry containing two types of abrasion particles, wherein the surface of the glass substrate polished with the finish polishing has an arithmetic mean roughness Ra controlled within 1.0 nm and with a precision in the range of ±0.05 nm.

6. A glass substrate for a magnetic recording medium that is manufactured by the method according to claim 5, wherein the slurry contains a first type of abrasion particles and a second type of abrasion particles having a diameter different from that of the first type of abrasion particles, in a predetermined mixing ratio.

7. A glass substrate for a magnetic recording medium that is manufactured by the method according to claim 6, wherein the slurry further contains an additive of salt in a predetermined concentration.

8. A glass substrate for a magnetic recording medium that is manufactured by the method according to claim 7, wherein the slurry further contains an additive of acid or alkali in an amount so as to exhibit a predetermined hydrogen ion concentration exponent (pH).

9. A magnetic recording medium comprising:
a glass substrate for a magnetic recording medium according to claim 5; and
at least a soft-magnetic layer, an orientation control layer, and a perpendicular recording layer sequentially laminated on a surface of the glass substrate to produce a magnetic recording medium.

10. A magnetic recording medium comprising:
a glass substrate for a magnetic recording medium according to claim 6; and
at least a soft-magnetic layer, an orientation control layer, and a perpendicular recording layer sequentially laminated on a surface of the glass substrate to produce a magnetic recording medium.

11. A magnetic recording medium comprising:
a glass substrate for a magnetic recording medium according to claim 7; and
at least a soft-magnetic layer, an orientation control layer, and a perpendicular recording layer sequentially laminated on a surface of the glass substrate to produce a magnetic recording medium.

12. A magnetic recording medium comprising:
a glass substrate for a magnetic recording medium according to claim 8; and
at least a soft-magnetic layer, an orientation control layer, and a perpendicular recording layer sequentially laminated on a surface of the glass substrate to produce a magnetic recording medium.
